(19) United States
(12) Patent Application Publication
(10) Pub. No.: US 2021/0038345 A1
(43) Pub. Date: Feb. 11, 2021

(54) Handle for Oral Hygiene Tool

(71) Applicant: Triple Bristle Inc., Dayton, TN (US)

(72) Inventors: Maxim Babiner, Feasterville, PA (US); Jacob R. Dent, Richmond, TX (US)

(21) Appl. No.: 16/534,975

(22) Filed: Aug. 7, 2019

(51) Int. Cl. A61C 5/82; A61C 3/00; A61C 15/04; A61C 17/22; B25G 1/10; B25G 3/02

(52) U.S. Cl. CPC A61C 5/82; A61C 3/00; A61C 15/047; A61C 15/048; A61C 2204/002; A61C 17/225; B25G 1/102; B25G 3/02; A61C 17/224

(57) ABSTRACT

Disclosed herein are embodiments for a handle for securing a patient's mouth in place while an oral procedure is performed. A handle includes a handle head extending from a handle body, the handle head comprising exterior border bumpers to the sides. An indented portion lies in between the border bumpers, the indented portion having grooves oriented substantially perpendicular to a length of the border bumpers. The indented region is configured to receive a patient's teeth and lock the patient's mouth open by preventing the teeth from sliding off the surface of the handle head. With the patient's mouth securely open, a caregiver may then use a second tool (e.g., a toothbrush, flosser, tongue cleaner, etc.) for cleaning the patient's mouth or performing any other oral procedure.

### BACKGROUND

### Technical Field

Embodiments generally relate to oral hygiene tools and, in particular, to a handle for assisting in oral hygiene of special needs individuals.

### Background

Oral hygiene for persons with disabilities or special needs presents unique challenges for care-givers. Persons with special needs may be unable to brush their teeth on their own, for example, due to physical disabilities, learning difficulties, or emotional or behavioral problems. Typically, a care-giver will work with the special needs person to perform routine oral hygiene procedures, such as brushing their teeth, flossing, scraping their tongue, etc. However, depending on the level of compliance of the person with special needs, assisting on these oral hygiene procedures can be difficult and even dangerous.

A typical problem for care-givers is maintaining the patient's mouth open for tooth-brushing. The patient may simply refuse to open her mouth, or even worse, close it or bite while the care-giver is brushing. While some tools and methods exist to deal with this problem, there is still a need for tools that can help care-givers to effectively and safely provide dental hygiene to special needs patients.

### BRIEF DESCRIPTION OF THE DRAWINGS

The accompanying drawings are incorporated herein and form a part of the specification.

FIG. 1 shows a perspective view of a handle for securing a patient's mouth in place while an oral procedure is performed, according to an example embodiment.

FIG. 2 shows a detailed close-up of the handle head, according to an example embodiment.

FIG. 3 shows a front view of the handle, according to an example embodiment.

FIG. 4 shows a back view of the handle, according to an example embodiment.

FIG. 5 shows a side view of the handle, according to an example embodiment.

FIG. 6 illustrates a method for using the handle in cooperative patients.

FIG. 7 illustrates a method for using the handle in non-cooperative patients.

### DETAILED DESCRIPTION

Provided herein are embodiments for a handle for securing a patient's mouth in place while an oral procedure is performed.

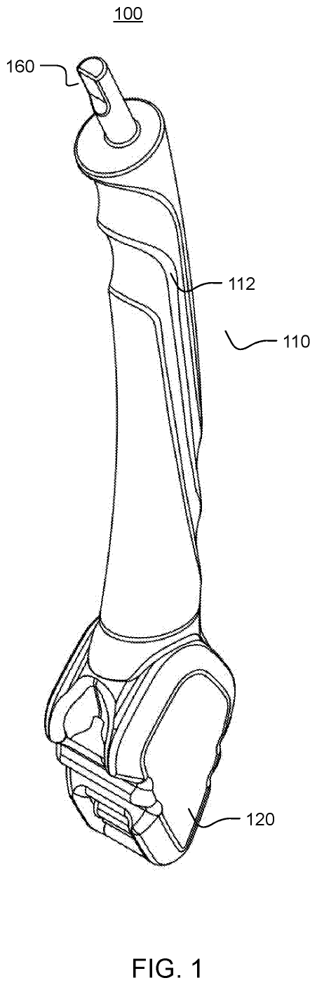

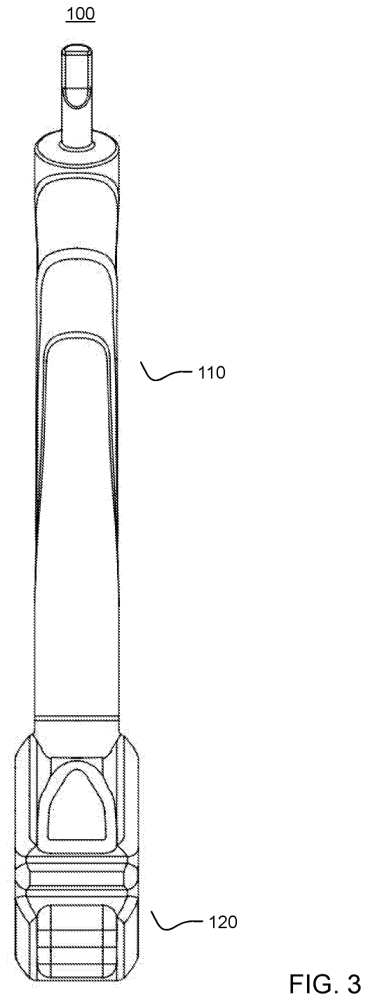

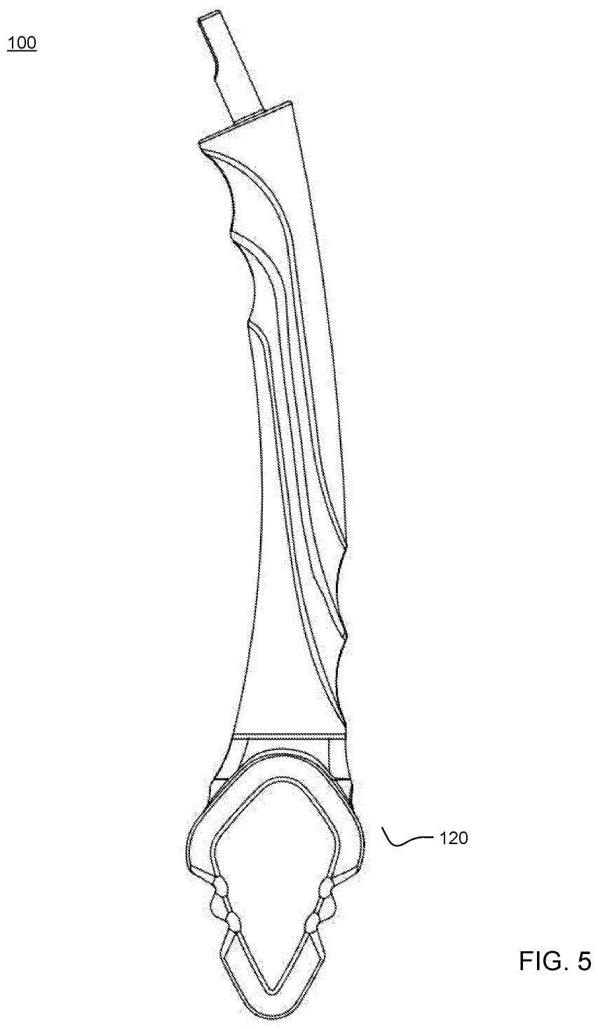

FIG. 1 shows a perspective view of a handle 100, according to particular embodiments. FIGS. 3-5 show front, back and side views, respectively. Handle 100 includes a handle body 110 and a handle head 120 extending from the body 110. Handle body 110 may be comprised of plastic materials, rubber materials, or any combination thereof. In particular embodiments, handle body 110 is made of plastic with a gripping pattern 112 made of rubber.

In particular embodiments, handle 100 further includes a connector 160 for receiving any suitable attachments, such as a brush-head, tongue cleaner, flosser, etc. In these embodiments, handle 100 can serve dual-purposes of a tool to secure patient mouth position and a standard mouth hygiene tool. In particular embodiments, handle 100 includes an electrical power source (e.g, battery, pluggable power supply, etc.) for generating vibrations and serving as an electric toothbrush. Handle 100 may further comprise a power socket plugging in a battery charger (not shown).

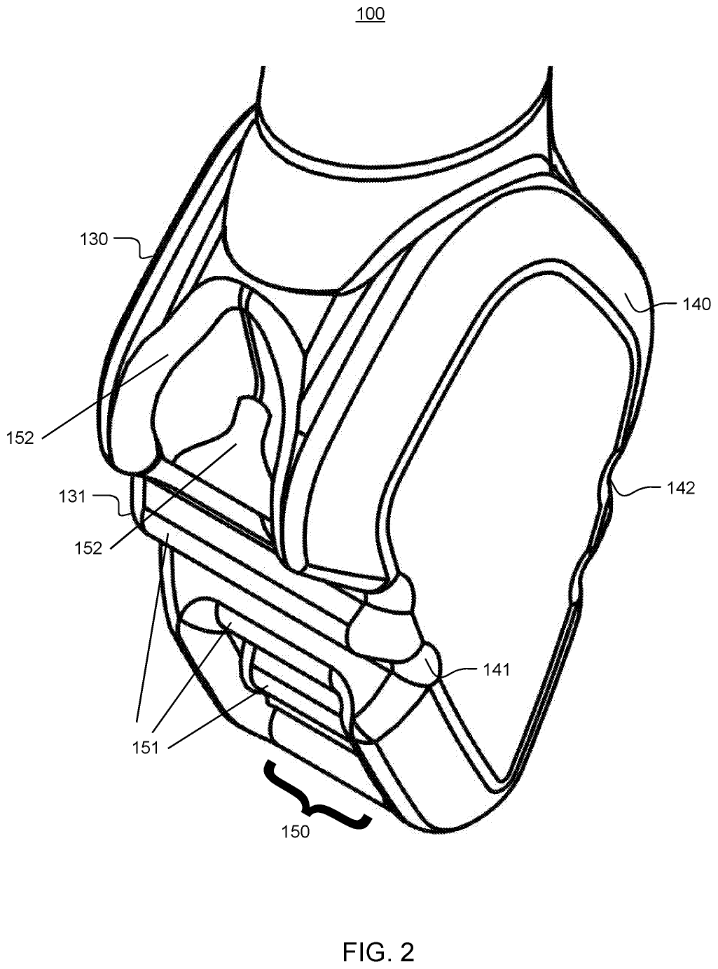

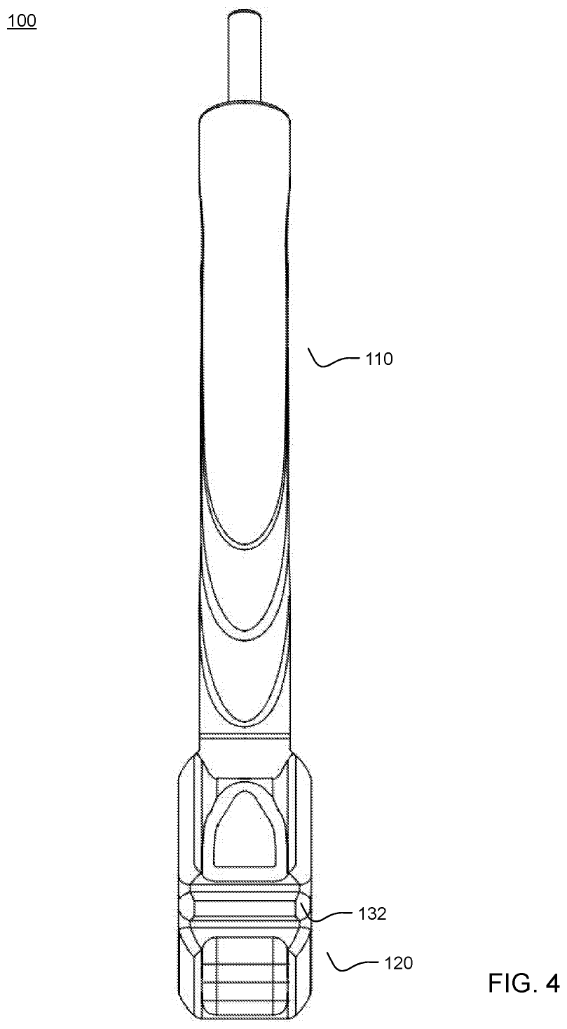

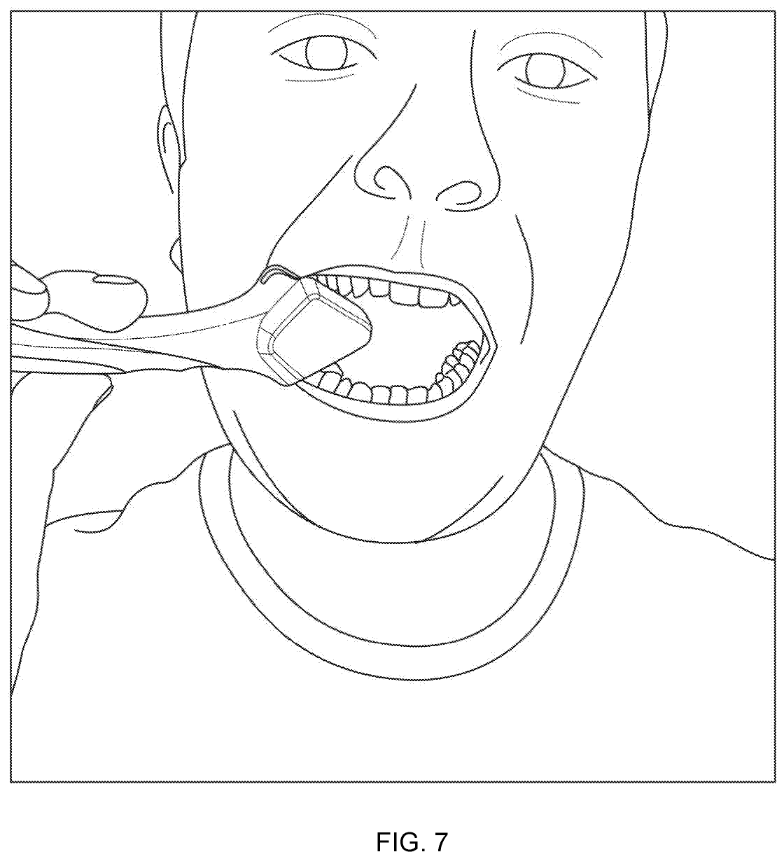

Handle head 120 is configured to be inserted into a patient's mouth to hold the patient's jaw substantially in place while a care-giver can reach into the mouth for cleaning. FIG. 2 shows a detailed close-up of handle head 120. Handle head 120 has a generally rhombus shape, and comprises exterior border bumpers 130 and 140 that wrap around a circumference of the handle head substantially parallel to the length of handle 100. In particular embodiments, bumper 130 includes gaps 131 and 132 (visible in FIG. 4) on opposite sides substantially perpendicular to the length of handle 100, while bumper 140 includes gaps 141 and 142 on opposite sides substantially perpendicular to the length of handle 100. Gaps 141 and 142 form a side biting surface that can accommodate a patient's bite from a side position, as shown in FIG. 7.

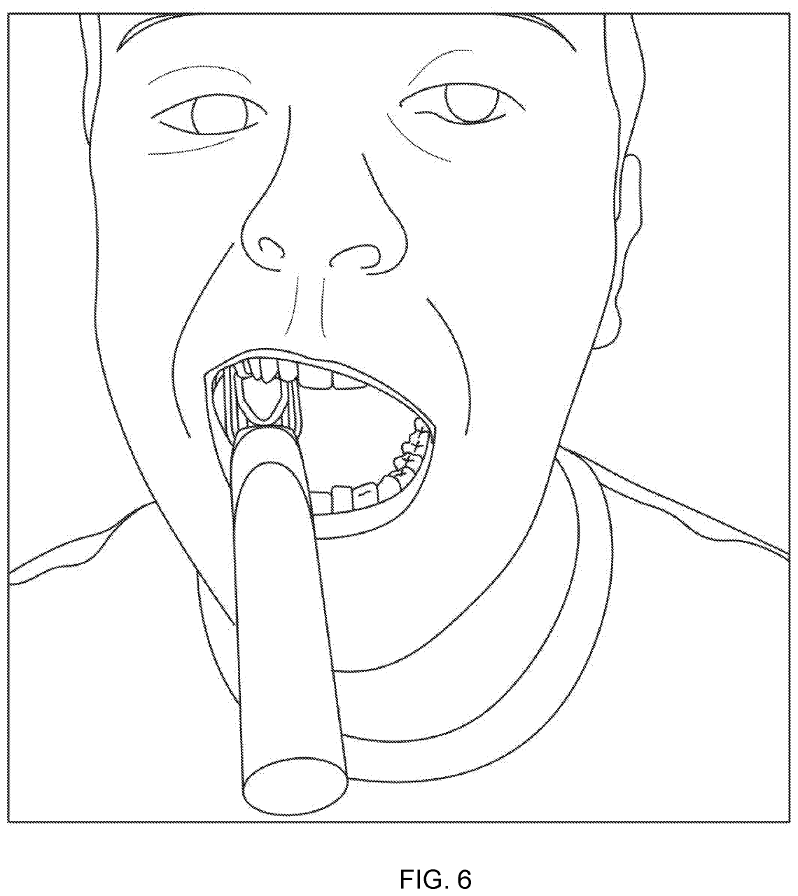

Handle head 120 has an indented region 150 for receiving teeth lengthwise (as shown in FIG. 6) between bumpers 130 and 140. Indented region 150 includes a plurality of grooves 151 and an opening 152. Grooves 151 generally serve to maintain a grip on a patient's teeth to help maintain head 120 in place in a non-cooperative patient. In particular embodiments, at least one groove on each side extends through the corresponding gaps 131, 132, 141, and 142. Opening 152 serves to lock the patient's bite in place and prevent the patient from pulling away from the handle. In particular embodiments, opening 152 comprises a c-shaped border 153 that servers to make contact with a tooth and keep the handle head from sliding too deep into the patient's mouth. Indented region 150 is thus configured to receive a patient's teeth and lock the person's mouth open by preventing the teeth from sliding off the surface of the handle head.

Handle head bumpers and indented region may be made of any suitable combination of plastic and rubber materials. In particular embodiments, bumpers 130 and 140 are made of a hard plastic that serves to keep teeth from sliding off to the sides when the patient is biting down on the indented region. In particular embodiments, indented region is made of a rubber material that provides comfort for a patient biting down.

As mentioned above, handle 100 may be used in various manners depending on the level of cooperation or compliance of a patient. FIG. 6 shows a method of using handle 100 that is best suited for non-cooperative patients, i.e., patients that may not want to have their teeth cleaned and may refuse to open their mouth or attempt to bite the care-giver. In this scenario, the handle is inserted lengthwise into the patient's mouth and the indented region 150 is aligned with the back molars of the patient. As the patient bites down on indented region 150, their jaw is locked in place in between the bumpers 130 and 140, so the handle head will not slide to the sides. Grooves 151 and opening 152 prevent the handle head from sliding too far into or out of the mouth. With the patient's mouth securely open, a caregiver may then use a second tool (e.g., a toothbrush, flosser, tongue cleaner, etc.) for cleaning the patient's mouth.

FIG. 7 shows a method of using handle 100 that is best suited for compliant or cooperative patients. In this scenario, the handle is inserted sideways into the mouth, and the patient can bite down onto the indented region 150 through gaps 131, 132, 141, and 142. This positioning would not lock teeth as securely as the method of FIG. 6, but would allow a care-giver more space to reach into the patient's mouth. Thus, for cooperative patients, the side position can aid the patient's to keep their mouth open while facilitating cleaning by the caregiver.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A handle for oral hygiene comprising:
a handle body;
a handle head extending from the handle body, the handle head comprising:
a first exterior border bumper positioned at one side of the handle head;
a second exterior border bumper positioned at a second side of the handle head;
an indented portion in between the border bumpers, the indented portion having one or more grooves oriented substantially perpendicular to a length of the border bumpers.

2. The handle of claim 1, wherein the first bumper has gaps on both sides that allow at least one groove on each side to extend through the corresponding gaps.

3. The handle of claim 3, wherein the second bumper has gaps on both sides that allow at least one groove on each side to extend through the corresponding gaps.

4. The handle of claim 1, wherein the first and second exterior border bumpers follow a substantially rhombus shape lengthwise from a handle length.

5. The handle of claim 4, wherein the one or more grooves are positioned on two sides of the rhombus furthest from the handle body.

6. The handle of claim 5, further comprising an c-shaped border opening away from the handle body, the border positioned on the handle head between the one or more grooves and the handle body.

7. The handle of claim 1, wherein the handle body comprises a connector for receiving an attachment.

8. The handle of claim 7, wherein the attachment comprises at least one of a toothbrush, a flosser, and a tongue cleaner.

9. The handle of claim 1, wherein the handle body comprises:
a toothbrush head removably coupled an end of the body opposite to the handle head; and
a power source for generating vibrations on the toothbrush head.

10. The handle of claim 9 wherein the power source comprises a rechargeable battery disposed within the handle.

11. The handle of claim 7, further comprising a power socket for charging the battery.

12. The handle of claim 1, wherein the first and second exterior border bumpers head comprise a plastic material, and the indented portion comprises a rubber material.

13. The handle of claim 1, wherein the handle body comprises a plastic material and a rubber material.

14. A handle for oral hygiene comprising:
a handle body;
a handle head extending from the handle body, the handle head comprising:
a first exterior border bumper positioned at one side of the handle head;
a second exterior border bumper positioned at a second side of the handle head;
an indented portion in between the border bumpers, the indented portion having one or more grooves.

15. The handle of claim 1, wherein the first bumper has gaps on both sides that allow at least one groove on each side to extend through the corresponding gaps.

16. The handle of claim 3, wherein the second bumper has gaps on both sides that allow at least one groove on each side to extend through the corresponding gaps.

17. The handle of claim 1, wherein the first and second exterior border bumpers follow a substantially rhombus shape lengthwise from a handle length.

18. The handle of claim 4, wherein the one or more grooves are positioned on two sides of the rhombus furthest from the handle body.

19. The handle of claim 5, further comprising an c-shaped border opening away from the handle body, the border positioned on the handle head between the one or more grooves and the handle body.

20. The handle of claim 1, wherein the first and second exterior border bumpers head comprise a plastic material, and the indented portion comprises a rubber material.
